(19) United States
(12) Patent Application Publication
(10) Pub. No.: US 2009/0033224 A1
(43) Pub. Date: Feb. 5, 2009

(54) Plasma display panel and method of manufacturing the same

(76) Inventors: Joe-Oong Hahn, Suwon-si (KR); Tae-Joung Kweon, Suwon-si (KR); Sung-Yong Lee, Suwon-si (KR); Yong-Woo Jung, Suwon-si (KR); Seung-Beom Seo, Suwon-si (KR); Jang-Woo Lee, Suwon-si (KR); Hee-Joun You, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/219,620

(22) Filed: Jul. 24, 2008

(30) Foreign Application Priority Data
Aug. 3, 2007 (KR) 10-2007-0078163

(51) Int. Cl. H01J 17/49; H01J 9/02

(52) U.S. Cl. 313/582; 445/24

(57) ABSTRACT

A plasma display panel and a method of manufacturing the plasma display panel are provided. The plasma display panel includes: a plurality of substrates including a first substrate and a second substrate disposed to face the first substrate; a plurality of barrier ribs disposed between the first substrate and the second substrate and defining a plurality of discharge spaces; a plurality of discharge electrodes disposed between the first substrate and the second substrate; phosphor layers formed in the discharge spaces; and an external light shield layer formed inside the substrates.

### CLAIM OF PRIORITY

This application makes reference to, incorporates the same herein, and claims all benefits accruing under 35 U.S.C.§119 from an application earlier filed in the Korean Intellectual Property Office on Aug. 3, 2007 and there duly assigned Serial No. 10-2007-0078163.

### BACKGROUND OF THE INVENTION

1. Field of the Invention

The present invention relates to a plasma display panel, and more particularly, to a plasma display panel having an external light shield layer formed inside a substrate, thereby achieving an excellent bright room contrast, and a method of manufacturing the same.

2. Description of the Related Art

A plasma display panel is a flat panel display device that displays desired numbers, letters, or graphics using visible light emitted from phosphor layers excited by ultraviolet rays generated during a gas discharge initiated by applying a discharge voltage to a plurality of discharge electrodes formed on a plurality of substrates after a discharge gas is sealed between the plurality of substrates.

Generally, plasma display panels can be classified into direct current (DC) plasma display panels and alternating current (AC) plasma display panels according to the type of driving voltage applied to discharge cells, i.e., according to the discharge type. Plasma display panels can further be classified into facing discharge plasma display panels and surface discharge plasma display panels according to the arrangement of electrodes.

A conventional three-electrode surface discharge type plasma display panel includes a first substrate, a second substrate, a pair of discharge sustain electrodes, i.e. an X electrode and a Y electrode, formed on an upper surface of the first substrate, a first dielectric layer burying the pair of discharge sustain electrodes, a protective film layer formed on a surface of the first dielectric layer, an address electrode disposed on an upper surface of the second substrate crossing the pair of discharge sustain electrodes, a second dielectric layer burying the address electrode, a barrier rib structure disposed between the first substrate and the second substrate, and red, green, or blue phosphor layers formed on sidewalls of the barrier rib structure. A discharge gas is injected into a space formed by the first substrate, the second substrate, and the barrier rib structure to form a discharge area.

In the conventional three-electrode surface discharge type plasma display panel, an electrical signal is applied to the Y electrode and the address electrode to select a discharge cell, and then the electrical signal is alternately applied to the X electrode and the Y electrode of the discharge cell so that a surface discharge is generated from the surface of the first substrate to generate ultraviolet rays, and visible light is emitted from a phosphor layer in the selected discharge cell. Thus, a stationary image or a moving image can be generated.

However, in the conventional three-electrode surface discharge type plasma display panel, bright room contrast is degraded due to reflection of incident external light. In order to prevent such degradation of bright room contrast, a black stripe layer is patterned on the surface of substrates, the first dielectric layer and the barrier rib structure have complementary colors, a micro array with a black strip (MAB) is formed on the surface of the substrates, or the like. However, the above conventional processes are complex, degrade brightness, increase manufacturing costs, and so on.

### SUMMARY OF THE INVENTION

The present invention provides a plasma display panel in which an external light shield layer is patterned inside a substrate by laser processing thereby achieving an excellent bright room contrast, and a method of manufacturing the same.

According to an aspect of the present invention, there is provided a plasma display panel comprising: a plurality of substrates including a first substrate and a second substrate disposed to face the first substrate; a plurality of barrier ribs disposed between the first substrate and the second substrate and defining a plurality of discharge spaces; a plurality of discharge electrodes disposed between the first substrate and the second substrate; phosphor layers formed in the discharge spaces; and an external light shield layer formed inside the substrates.

The visible light may pass through the substrates in which the external light shield layer is formed.

A distance between the surface of the substrates in which the external light is incident and the surface of the substrates in which the external light shield layer may be formed is less than 1 mm.

The external light shield layer may be patterned inside the substrates that correspond to the barrier ribs.

The external light shield layer may have a color that is close to black.

According to another aspect of the present invention, there is provided a method of manufacturing a plasma display panel, the method comprising: preparing a substrate; and irradiating a laser beam inside the substrate and forming an external light shield layer inside the substrate.

The laser beam may be irradiated by adjusting a focus point at a distance of less than 1 m from the surface of the substrate.

The external light shield layer may be formed by crystallizing an area inside the substrate to which the laser beam is irradiated.

The external light shield layer may be formed by inserting one selected from a black-like colored metal material, an organic material, and an inorganic material into a crystal boundary inside the crystallized area inside the substrates.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional plasma display panel in which external light is incident and reflected;

FIG. 2 is a perspective view of a plasma display device according to an embodiment of the present invention;

FIG. 3 is a perspective cross-sectional view of a plasma display panel according to an embodiment of the present invention;

FIG. 4 is a cross-sectional view of the plasma display panel taken along a line IV-IV illustrated in FIG. 3, according to an embodiment of the present invention;

FIG. 5 is an enlarged perspective view of an external light shield layer according to an embodiment of the present invention;

FIGS. 6A through 6D are schematic diagrams for explaining a process of forming an external light shield layer according to another embodiment of the present invention; and

FIG. 7 is a cross-sectional view of a substrate in which external light is incident according to an embodiment of the present invention.

### DETAILED DESCRIPTION OF THE INVENTION

Before describing embodiments of the present invention, the overall feature of the technical idea of the present invention will be described in order to gain a sufficient understanding of the present invention.

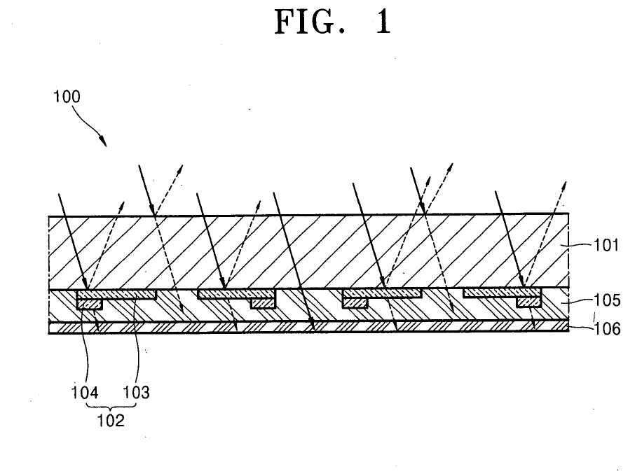

FIG. 1 is a cross-sectional view of a conventional plasma display panel 100 in which external light is incident and reflected.

Referring to FIG. 1, a pair of discharge electrodes 102 is patterned on the inner surface of a substrate 101. The pair of discharge electrodes 102 includes a transparent electrode 103 that contacts the inner surface of the substrate 101 and is formed of a transparent conductive film, and a bus electrode 104 that is formed of a metal film having excellent conductivity in order to reduce line resistance. The pair of discharge electrodes 102 is buried in a dielectric layer 105. A protective film 106 is formed on the surface of the dielectric layer 105.

In the plasma display panel 100 having the above structure, if external light is incident (solid lines), some of the external light is transparent or reflected (dotted lines). The bright room contrast of the plasma display panel 100 is dramatically degraded due to the reflection of external light.

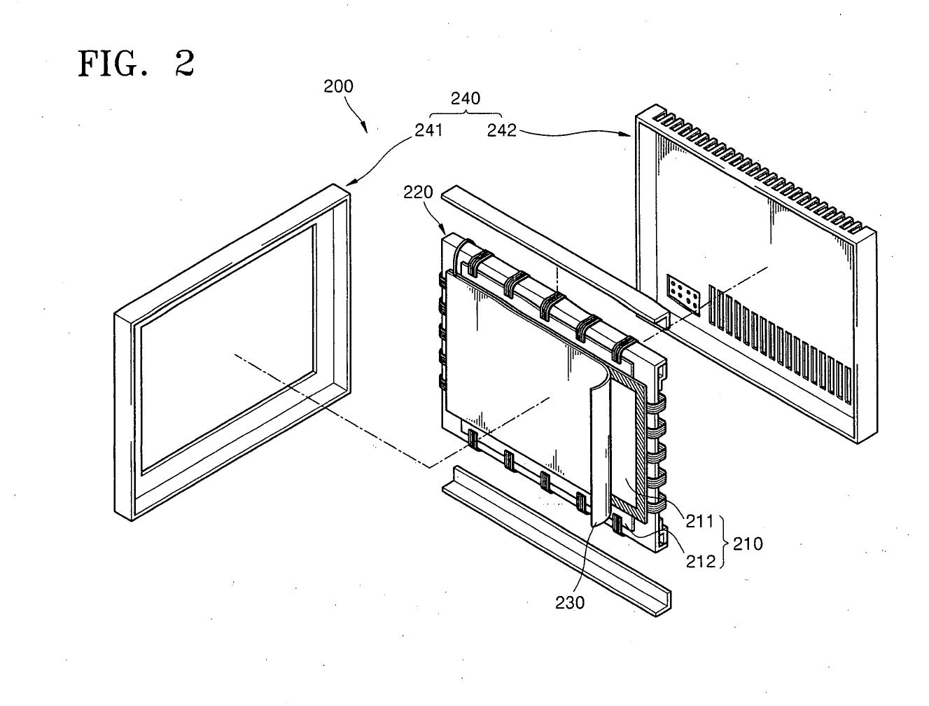

FIG. 2 is a perspective view of a plasma display device 200 according to an embodiment of the present invention.

Referring to FIG. 2, the plasma display device 200 includes a plasma display panel 210, a chassis base assembly 220 connected to the rear of the plasma display panel 210, a filter assembly 230 adhered to the front of the plasma display panel 210, and a case 240 storing the plasma display panel 210, the chassis base assembly 220, and the filter assembly 230.

The plasma display panel 210 includes a first substrate 211 and a second substrate 212 connected to the first substrate 211. An inner space between the front substrate 211 and the second substrate 212 is sealed from the outside by coating a sealant (not shown) along inner edges of the front substrate 211 and the second substrate 212 that are facing each other.

The filter assembly 230 is adhered to the front of the first substrate 211. The chassis base assembly 220 is connected to the rear of the second substrate 212. The filter assembly 230 is formed by stacking a plurality of functional films in order to block electromagnetic waves, ultraviolet rays, neon luminescent light or the reflection of external light that is generated from the plasma display panel 210.

The case 24 includes a front cabinet 241 that is installed in the front of the filter assembly 230 and a cover back 242 that is installed in the rear of the chassis base assembly 220.

An external light shield layer is formed inside the first substrate 211 in order to improve bright room contrast. This will be described in more detail below.

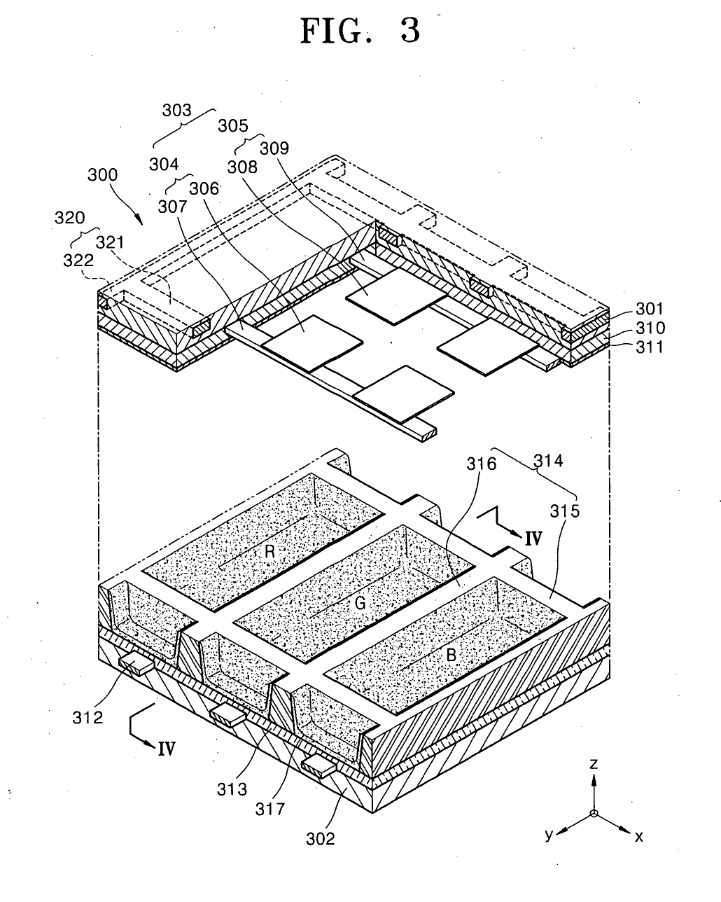

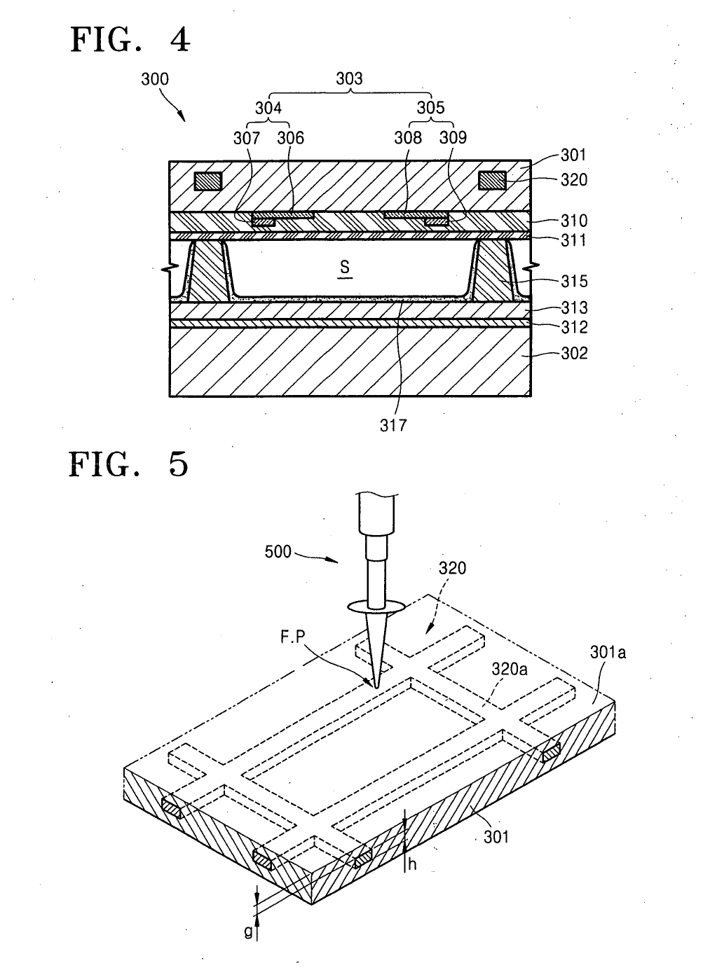

FIG. 3 is a perspective cross-sectional view of a plasma display panel 300 according to an embodiment of the present invention. FIG. 4 is a cross-sectional view of the plasma display panel taken along a line IV-IV illustrated in FIG. 3, according to an embodiment of the present invention.

Referring to FIGS. 3 and 4, the plasma display panel 300 includes a first substrate 301 and a second substrate 302, which face each other and are spaced apart from each another by a predetermined gap. Frit glass (not shown) is coated along edges of inner surfaces of the first substrate 301 and the second substrate 302 so that discharge cells are sealed from the outside.

The first substrate 301 is a transparent substrate such as a soda lime glass. Alternatively, the first substrate 301 can be a semi-transparent substrate, a colored substrate, or a reflective substrate.

A pair of discharge sustain electrodes 303 is disposed in the first substrate 301. The pair of discharge sustain electrodes 303 includes an X electrode 304 and a Y electrode 305. The X electrode 304 includes an X transparent electrode 306 and an X bus electrode 307 connected to the X transparent electrode 306. The Y electrode 305 includes a Y transparent electrode 308 and a Y bus electrode 309 connected to the Y transparent electrode 308.

The X electrode 304 and the Y electrode 305 are buried in a first dielectric layer 310. The first dielectric layer 310 is formed of a highly dielectric material, i.e., ZnO—B₂O₃—Bi₂O₃. The first dielectric layer 310 can be selectively formed on the inner surface of the first substrate 301 in which the X electrode 304 and the Y electrode 305 are formed, or on the entire inner surface of the first substrate 301.

A protective film layer 311 such as an MgO layer is deposited on the surface of the first dielectric layer 310 in order to prevent the first dielectric layer 310 from being damaged and to emit a greater amount of secondary electrons.

The second substrate 302 can be substantially formed of the same material as the first substrate 301. A plurality of address electrodes 312 are disposed on the second substrate 302 across the pair of discharge sustain electrodes 303 and buried in a second dielectric layer 313. The second dielectric layer 313 is formed of a highly dielectric material, i.e., ZnO—B₂O₃—Bi₂O₃.

A plurality of barrier ribs 314 are disposed between the first substrate 301 and the second substrate 302 to define a plurality of discharge cells between the first and second substrates 301 and 302. The plurality of barrier ribs 314 include first barrier ribs 315 extending in an X direction of the plasma display panel 300 and second barrier ribs 316 extending in a Y direction of the plasma display panel 300. The first barrier ribs 315 extend to cross the plurality of address electrodes 312. The second barrier ribs 316 extend parallel to the plurality of address electrodes 312.

The first barrier ribs 315 and the second barrier ribs 316 are stripe-shaped to define discharge spaces. For example, discharge spaces defined by the first barrier ribs 315 and the second barrier ribs 316 have rectangular cross-sections, but are not necessarily restricted thereto, and can have other cross-sectional shapes, such as circular cross sections, oval cross sections and the like.

A discharge gas such as a Ne—Xe gas or a He—Xe gas is filled in the discharge spaces defined by the first substrate 301, the second substrate 302, and the plurality of barrier ribs 314.

Also, red, green, and blue phosphor layers 317 that emit visible light when excited by ultraviolet rays generated by the discharge gas are formed in each of the discharge spaces. The phosphor layers 317 can be coated in any region contacting the discharge spaces.

The phosphor layers 317 are not necessarily limited to red, green, and blue phosphor layers but can be replaced with other color phosphor layers or can be formed of additional color phosphor layers. In the present embodiment, the red phosphor layer may be formed of (Y,Gd)BO₃;Eu⁺³, the green phosphor layer may be formed of Zn₂SiO₄:Mn²⁺, and the blue phosphor layer may be formed of BaMgAl₁₀O₁₇:Eu²⁺.

An external light shield layer 320 is formed inside the first substrate 301. Visible light generated due to the discharge of the plasma display panel 300 transmits the first substrate 301. The external light shield layer 320 is formed by micro-arraying predetermined patterns inside the first substrate without any damage to the surface of the first substrate 301.

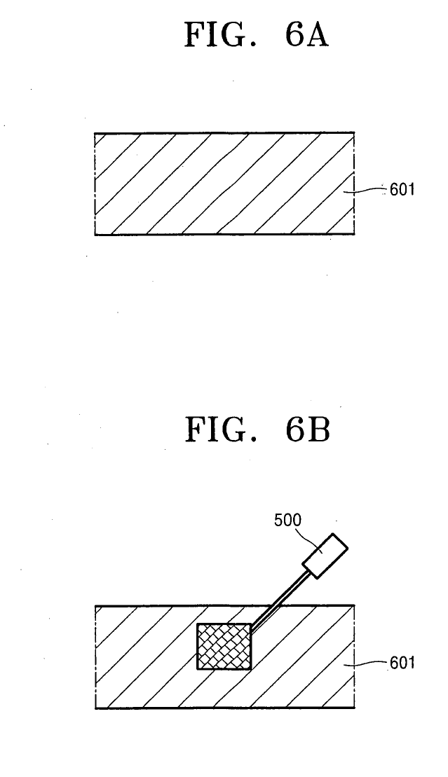

Referring to FIG. 5, which illustrates an enlarged perspective view of the external light shield layer 320 according to an embodiment of the present invention, the external light shield layer 320 is formed using sub-surface laser engraving (SSLE) that is a process of adjusting a focus point (FP) of a laser beam inside the first substrate 301 using a laser device 500, and engraving a desired pattern selectively on the focused part without any damage to the surface 301a of the first substrate 301.

The laser beam generated from the laser device 500 passes through the surface 301a of the first substrate 301, the FP of the laser beam is adjusted inside the first substrate 301, and the desired pattern is engraved on the focused-on part. This process can form the external light shield layer 320 of the desired pattern inside the first substrate 301 without any crack to the surface 301a of the first substrate 301.

The external light shield layer 320 formed by performing the SSLE has a color that is close to black. In more detail, the first substrate 301 has a transparent color due to a large energy band gap so that visible light transmits the first substrate 301, whereas the focused part inside the first substrate 301 has a smaller energy band gap due to the irradiated laser beam. Thus, the external light shield layer 320 has a black-like color, and does not transmit visible light but absorbs it.

The external light shield layer 320 can reduce reflection brightness of external light of the plasma display panel 300. In the present embodiment the laser beam is used to form the external light shield layer 320 having the black-like color but the present invention is not limited thereto. The external light shield layer 320 can be formed inside the first substrate 301 through which visible light is transmitted using a black-like material.

A distance g between the surface 301a of the first substrate 301 and the surface 320a of the external light shield layer 320 is less than 1 mm. If the distance g exceeds 1 mm, the external light shield layer 320 does not have a desired thickness g due to the limited thickness of the first substrate 301.

Referring back to FIGS. 3 and 4, the external light shield layer 320 may occupy the same space as the barrier ribs 314 in order to minimize an opening ratio of the first substrate 301.

Therefore, the external light shield layer 320 substantially has the same shape as that of the barrier ribs 314. In more detail, the external light shield layer 320 includes a first external light shield layer 321 that is formed inside the first substrate 301 and extends in a direction parallel to the first barrier ribs 315, and a second external light shield layer 322 that is formed inside the first substrate 301 and extends in a direction parallel to the second barrier ribs 316.

The width and thickness of the external light shield layer 320 may be the same as those of the barrier ribs 314 in order to prevent visible light generated from discharge cells from being blocked.

The operation of the plasma display panel 300 having the above structure according to an embodiment of the present invention will now be described.

A predetermined pulse voltage is applied between the Y electrodes 305 and the address electrodes 312 and thus a discharge cell that is to be luminescent is selected from the discharge cells. Wall charges are accumulated on sidewalls of the selected discharge cell.

A plus voltage is applied to the X electrodes 304 and a relatively higher voltage than the plus voltage is applied to the Y electrodes 305 so that the wall charges move due to a voltage difference between the X electrodes 304 and the Y electrodes 305.

The wall charges cause discharge gas atoms in the discharge cells to collide, a discharge occurs, and thus plasma is generated. The discharge spreads from a discharge gap between the X transparent electrode 306 and the Y transparent electrode 308 that have a strong electric field to edges of the discharge cells.

After the discharge occurs, if the voltage difference between the X electrodes 304 and the Y electrodes 305 is lower than a discharge voltage, the discharge no longer occurs and space charges and wall charges are formed in the discharge cells.

In this case, if polarities of the voltages applied to the X electrodes 304 and the Y electrodes 305 are reversed, the discharge resumes owing to the wall charges and thus an initial discharge operation is repeated. A repetition of the discharge operation results in a stable generation of the discharge.

Ultraviolet rays generated by the discharge excite phosphor substances of the red, green, and blue phosphor layers 317 that are disposed on each of the discharge cells and visible light is emitted from the phosphor layers 317 in the discharge cell. Thus, a stationary image or a moving image can be generated.

In this regard, the external light shield layer 320 having the black-like color and the corresponding shape to that of the barrier ribs 314 is formed inside the first substrate 301 and absorbs incident external light so that bright room contrast of the plasma display panel 300 can be improved.

The operation of forming the external light shield layer 320 according to an embodiment of the present invention will now be described.

Referring back to FIG. 5, the first substrate 301, through which visible light generated from the discharge cells when the discharge occurs is transmitted, is prepared.

The laser device 500 that is installed apart at a predetermined interval from the surface 301a of the first substrate 301 outputs a laser beam.

The laser beam adjusts the FP inside the first substrate 301. The FP of the laser beam travels to the inside of the first substrate 301 and thus the external light shield layer 320 having a desired shape, i.e., the corresponding shape to that of the barrier ribs 314, is formed.

The distance g, i.e., the part where the FP of the laser beam is adjusted, between the surface 301a of the first substrate 301 and the surface 320a of the external light shield layer 320 is less than 1 mm.

The external light shield layer 320 is crystallized due to an irradiated laser beam, light is scattered on the external light shield layer 320, and thus the light is seen as being opaque to the human eye. The external light shield layer 320 may have the black-like color in order to block external light efficiently.

In order to form the external light shield layer 320 having the black-like color, the intensity of the laser beam is adjusted so as to be around 10¹⁴ W/cm² higher than a glass damage threshold of the first substrate 301 and thus a micro arrayed pattern is formed inside the first substrate 301.

Alternatively, a black material can be used to form the external light shield layer 320 having the black-like color.

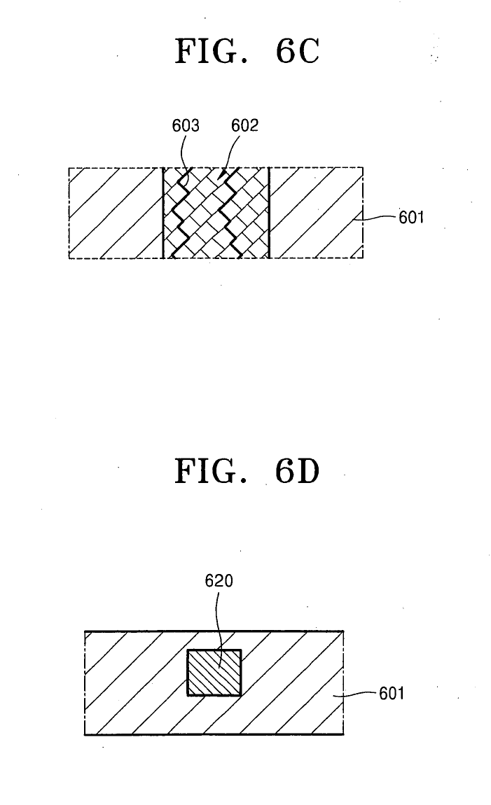

FIGS. 6A through 6D are schematic diagrams for explaining a process of forming an external light shield layer according to another embodiment of the present invention.

Referring to FIG. 6A, a substrate 601, through which visible light generated from a plasma display panel when a discharge occurs is transmitted, is prepared.

Referring to FIG. 6B, a laser device 500 installed in the upper portion of the substrate 601 outputs a laser beam. The laser beam focuses on a part inside the substrate 601 and crystallizes the focused part.

Referring to FIG. 6C, a crystal boundary is formed on the crystallized part 602. A material having a black-like color is inserted into the crystal boundary. In more detail, a path 603 in which the black-like colored material spreads in the crystal boundary is formed in the crystallized part 602. The black-like colored material can be an organic or inorganic material containing carbon whose color is turned black, or an element having the black-like color such as a black-like colored metal material of a periodic table or a molecule of the element.

Referring to FIG. 6D, the black-like colored material is manufactured as nano particles, nano particles are crystallized, and a small amount of the crystallized nano particles is inserted into the crystal boundary. The crystallized nano particles pass through the substrate 601 along the path 603 due to the capillary phenomenon and thus an external light shield layer having the black-like color can be formed.

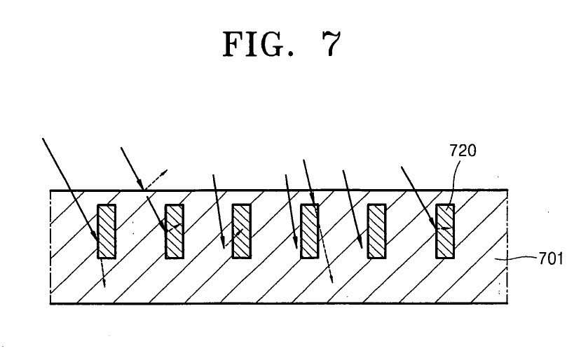

FIG. 7 is a cross-sectional view of a substrate 701 in which external light is incident according to an embodiment of the present invention. Referring to FIG. 7, an external light shield layer 720 formed inside the substrate 701 absorbs the external light that is incident in the substrate 701, so that the external light can be shielded against.

As described above, the plasma display panel and the method of manufacturing the same, of the present invention, form an external light shield layer having a black-like color inside a substrate, thereby absorbing external light that is incident from the outside. Therefore, bright room contrast of the plasma display panel can be greatly improved. Furthermore, the external light shield layer is formed inside the substrate using laser beam so that the plasma display panel can be easily manufactured.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A plasma display panel comprising:
a plurality of substrates including a first substrate and a second substrate disposed to face the first substrate;
a plurality of barrier ribs disposed between the first substrate and the second substrate and defining a plurality of discharge spaces;
a plurality of discharge electrodes disposed between the first substrate and the second substrate;
phosphor layers formed in the discharge spaces; and
an external light shield layer formed inside the substrates.

2. The plasma display panel of claim 1, wherein visible light passes through the substrates in which the external light shield layer is formed.

3. The plasma display panel of claim 2, wherein a distance between the surface of the substrates in which the external light is incident and the surface of the substrates in which the external light shield layer is formed is less than 1 mm.

4. The plasma display panel of claim 1, wherein the external light shield layer is patterned inside the substrates that correspond to the barrier ribs.

5. The plasma display panel of claim 4, wherein a thickness and width of the external light shield layer are the same as those of the barrier ribs.

6. The plasma display panel of claim 1, wherein the external light shield layer has a color that is close to black.

7. The plasma display panel of claim 1, wherein the external light shield layer is formed by crystallizing an area inside the substrates by laser engraving.

8. The plasma display panel of claim 7, wherein the external light shield layer is formed by inserting one selected from a black-like colored metal material, an organic material, and an inorganic material into a crystal boundary inside the crystallized area inside the substrates.

9. The plasma display panel of claim 1, wherein a filter assembly is adhered to the front of the substrates in which the external light shield layer is formed.

10. A method of manufacturing a plasma display panel, the method comprising:
preparing a substrate; and
irradiating a laser beam inside the substrate and forming an external light shield layer inside the substrate.

11. The method of claim 10, wherein the laser beam is irradiated by adjusting a focus point at a distance of less than 1 m from the surface of the substrate.

12. The method of claim 10, wherein the intensity of the laser beam is adjusted to be higher than a glass damage threshold of the substrate and the external light shield layer is directly inside the substrate.

13. The method of claim 10, wherein the external light shield layer is formed by crystallizing an area inside the substrate to which the laser beam is irradiated.

14. The method of claim 13, wherein the external light shield layer has a color that is close to black.

15. The method of claim 10, wherein the external light shield layer is formed by inserting one selected from a black-like colored metal material, an organic material, and an inorganic material into a crystal boundary inside the crystallized area inside the substrates.

16. The method of claim 10, wherein the external light shield layer has the same pattern as barrier ribs formed on the substrate.

17. The method of claim 16, wherein a thickness and width of the external light shield layer are the same as those of the barrier ribs.

18. A plasma display panel comprising:
a plurality of substrates including a first substrate and a second substrate disposed to face the first substrate;
a plurality of first and second barrier ribs disposed between the first substrate and the second substrate in which said first and second barrier ribs intersect perpendicular to each other and define a plurality of discharge spaces;
a plurality of discharge electrodes disposed between the first substrate and the second substrate;
phosphor layers formed in the discharge spaces; and
a first and second external light shield layer formed by micro-arraying predetermined patterns inside said first substrate,
wherein the first external light shield extends parallel to the first barrier ribs and the second external light shield extends parallel to the second barrier ribs.
